(19) United States
(12) Patent Application Publication
(10) Pub. No.: US 2022/0079354 A1
(43) Pub. Date: Mar. 17, 2022

(54) CONTAINER RACK AND METHOD

(71) Applicant: Sean Howard, Hudson, NY (US)

(72) Inventor: Sean Howard, Hudson, NY (US)

(21) Appl. No.: 17/475,667

(22) Filed: Sep. 15, 2021

Related U.S. Application Data
(60) Provisional application No. 63/079,556, filed on Sep. 17, 2020.

(51) Int. Cl. A47F 7/28; A47B 73/00; A47J 47/16

(52) U.S. Cl. CPC A47F 7/283; A47J 47/16; A47B 73/008; A47B 73/006

(57) ABSTRACT

A container rack including a base, the base including at least one base peg extending from a base top surface; and a first block, the first block including at least one first block container hole, and the first block including at least one base peg receiving hole on a first block bottom surface for receiving the base peg, and the first block including at least one stacking peg extending from a first block top surface; a second block, and the second block including at least one second block container hole, and the second block including at least one stacking peg receiving hole on a second block bottom surface for receiving the at least one stacking peg; and the base, first block, and second block connected and stacked.

### CROSS REFERENCE TO RELATED APPLICATION

This patent application claims the benefit under 35 U.S.C. § 119(e) of U.S. Provisional Patent Application Ser. No. 63/079,556, filed Sep. 17, 2020, which is incorporated by reference as though fully set forth herein.

### TECHNICAL FIELD

The subject matter of this invention relates to container racks and methods of deploying container racks.

### BACKGROUND

Storage of small items or bulk materials is often done in containers. Small items may include hardware, such as screws and nails, toys, such as game pieces or blocks, or food, such as candy. Bulk materials may include both solid and liquid materials, and may include food, such as spices or flour, or paint.

Homes and businesses benefit from efficient container racks. Container racks are designed to provide a number of benefits, including but not limited to, compactness, ease of access, and ease of identification.

### SUMMARY

Aspects of the disclosure describe a container rack, the container rack comprising: a base, wherein the base includes at least one base peg extending from a base top surface; a first block, wherein the first block includes at least one first block container hole, wherein the first block includes at least one base peg receiving hole on a first block bottom surface for receiving the base peg, and wherein the first block includes at least one stacking peg extending from a first block top surface; a second block, wherein the second block includes at least one second block container hole, and wherein the second block includes at least one stacking peg receiving hole on a second block bottom surface for receiving the at least one stacking peg; and wherein the base, first block, and second block are connected and stacked.

A second aspect discloses a container rack, the container rack comprising: a base, wherein the base includes at least one base peg and at least one stacking peg extending from a base top surface; a first block, wherein the first block includes at least one first block container hole, wherein the first block includes at least one base peg receiving hole on a first block bottom surface for receiving the at least one base peg; a second block, wherein the second block includes at least one second block container hole, wherein the second block includes at least one stacking peg receiving hole on a second block bottom surface for receiving the at least one stacking peg; wherein the base and first block are connected, and wherein the base and second block are connected

A third aspect discloses a method of deploying a container rack, the method comprising: connecting a first block to a base, wherein the base includes at least one base peg and the first block includes at least one base peg receiving hole for receiving the at least one base peg; and inserting at least one stacking peg into a first block top surface; and connecting a second block to the first block, wherein the second block includes at least one stacking peg receiving hole on a second block bottom surface for receiving the at least one stacking peg.

### BRIEF DESCRIPTION OF THE EXHIBITS

These and other features of this invention will be more readily understood from the following detailed description of the various aspects of the invention taken in conjunction with the accompanying exhibits and images in which:

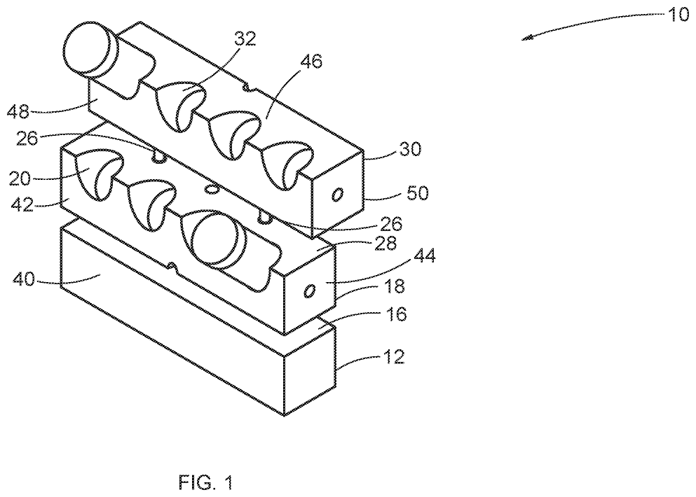

FIGS. 1-7 show various views of a container rack according to embodiments.

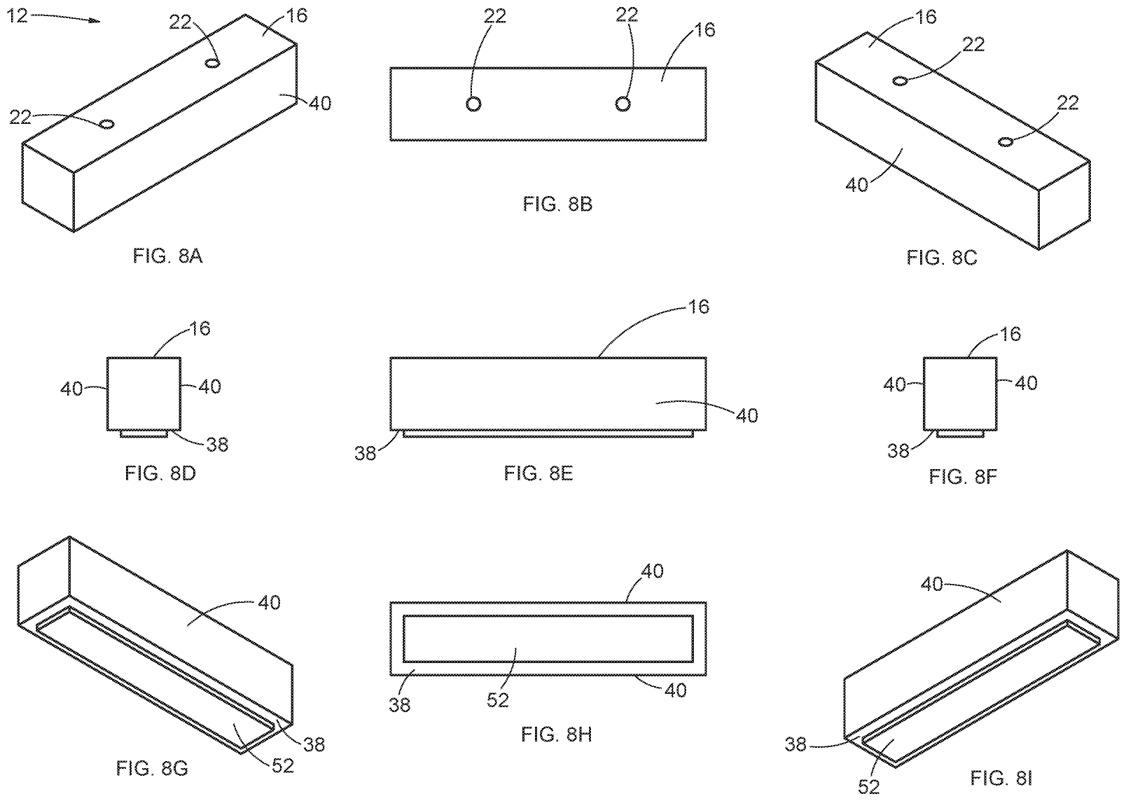

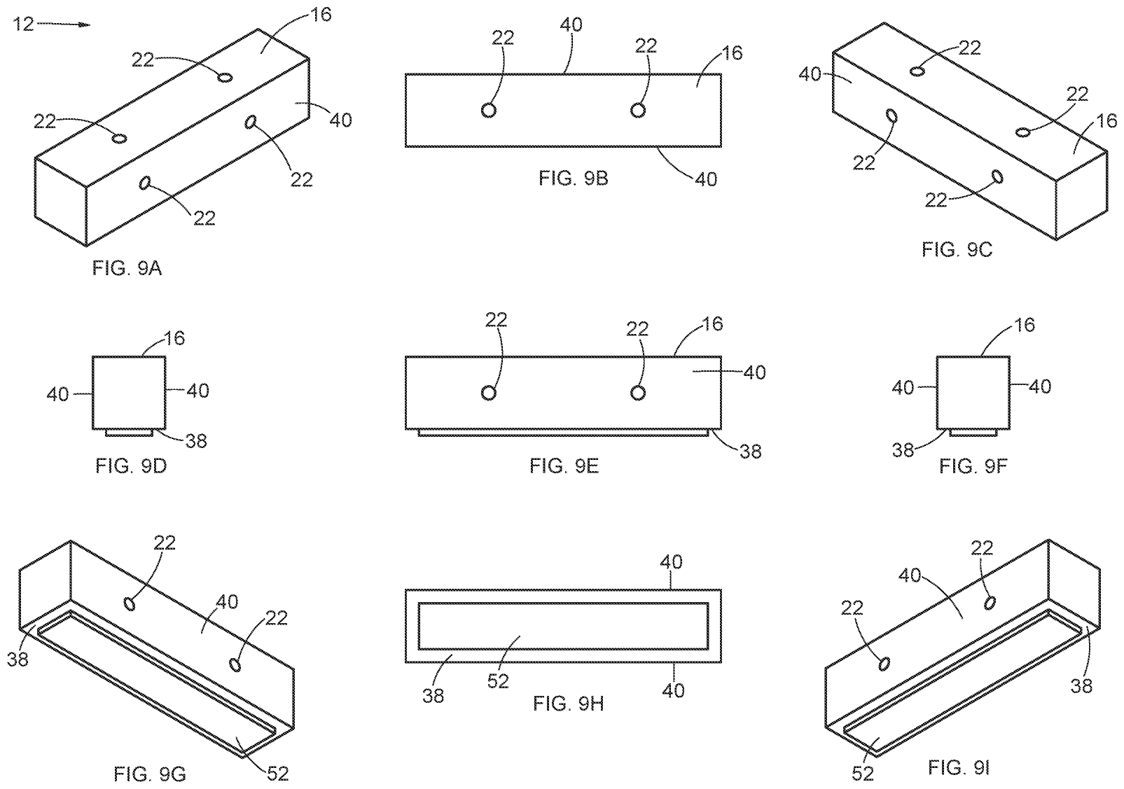

FIGS. 8A-8I and FIGS. 9A-9I show various views of a base block according to embodiments.

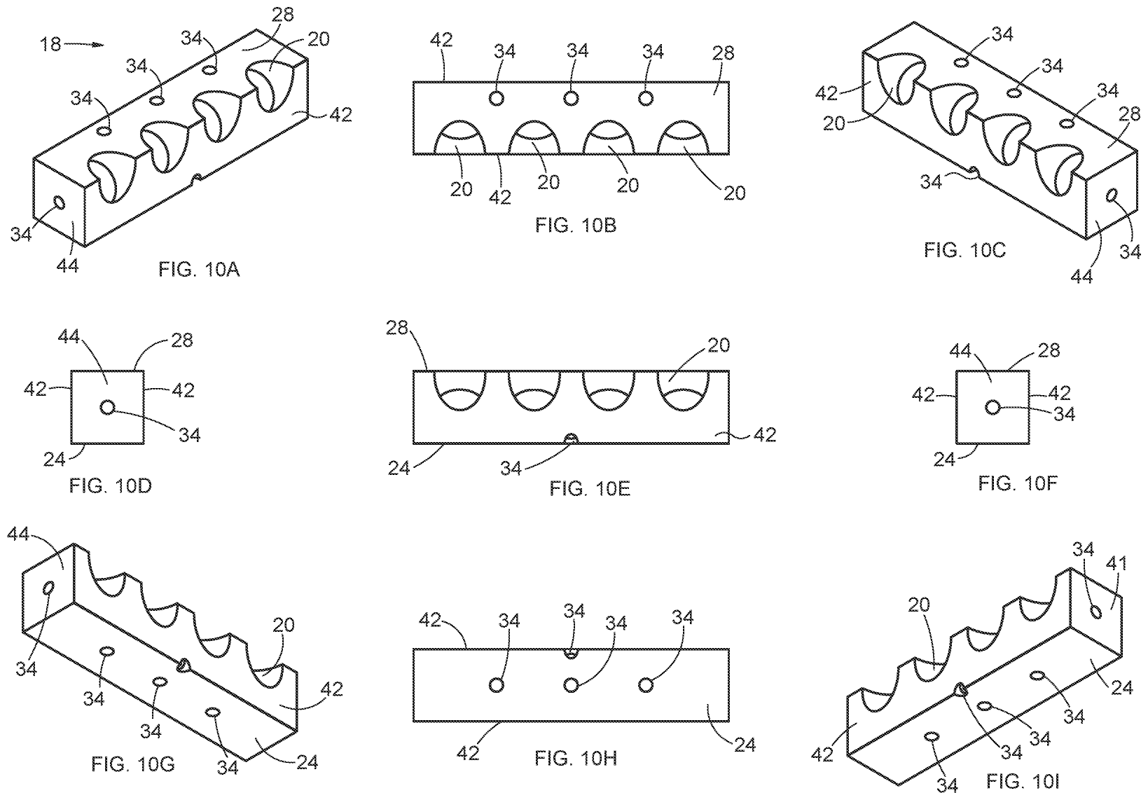

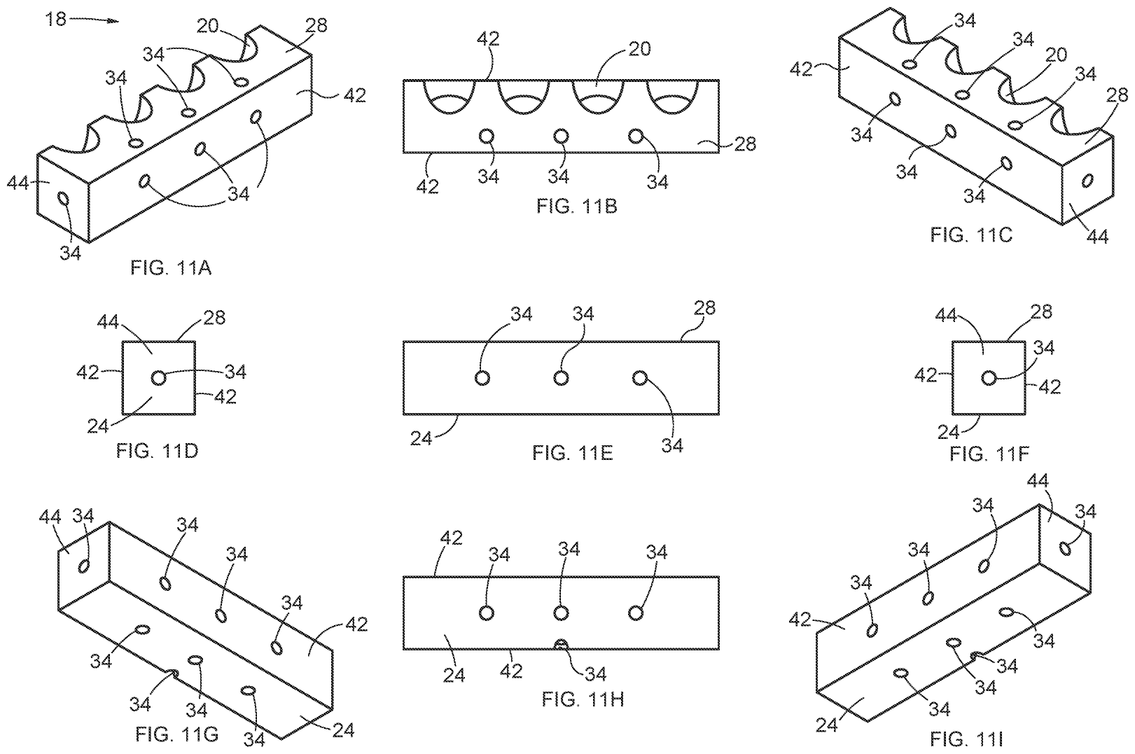

FIGS. 10A-10I and FIGS. 11A-11I show various views of a first block according to embodiments.

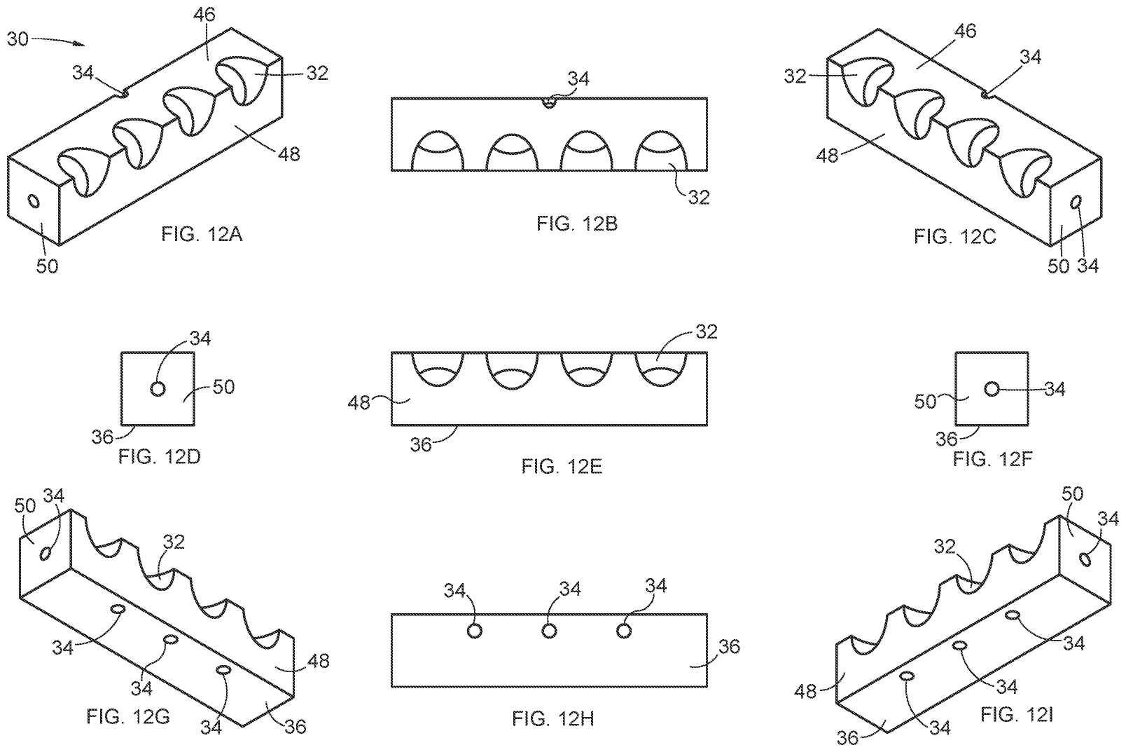

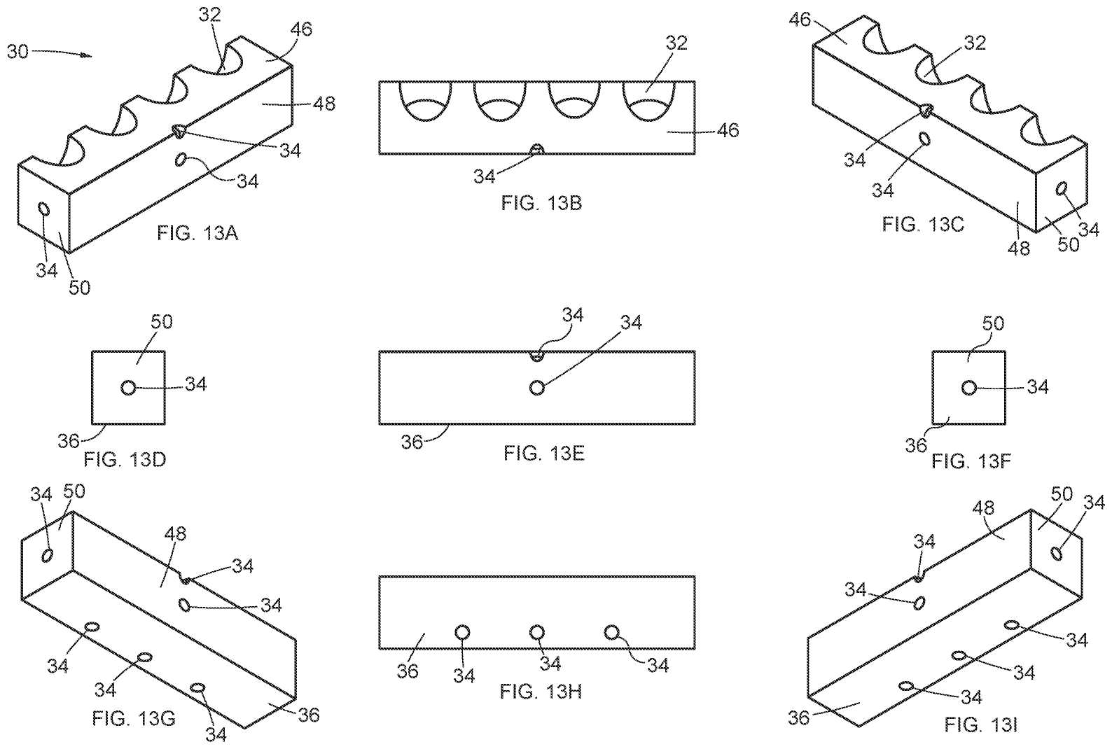

FIGS. 12A-12I and FIGS. 13A-13I show various views of a second block according to embodiments.

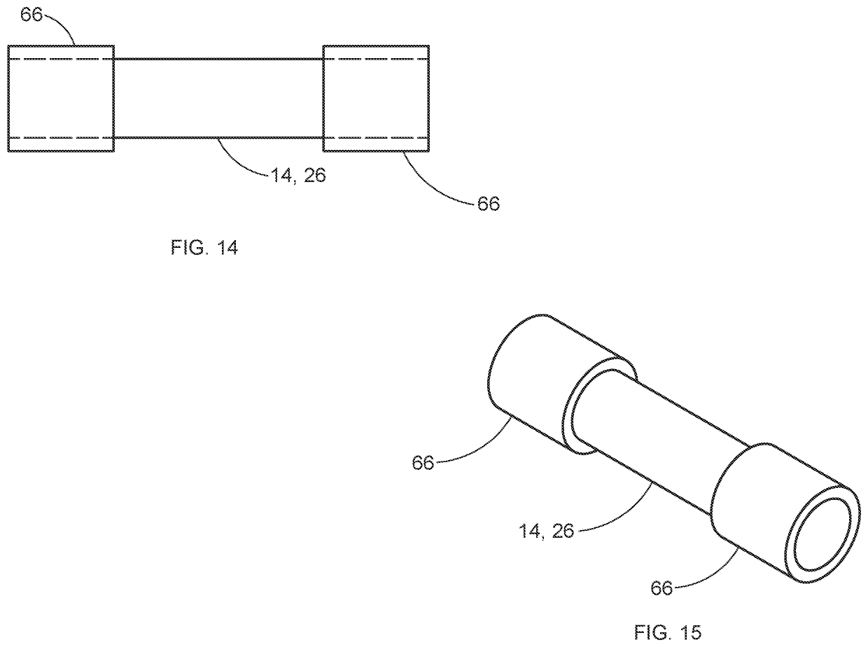

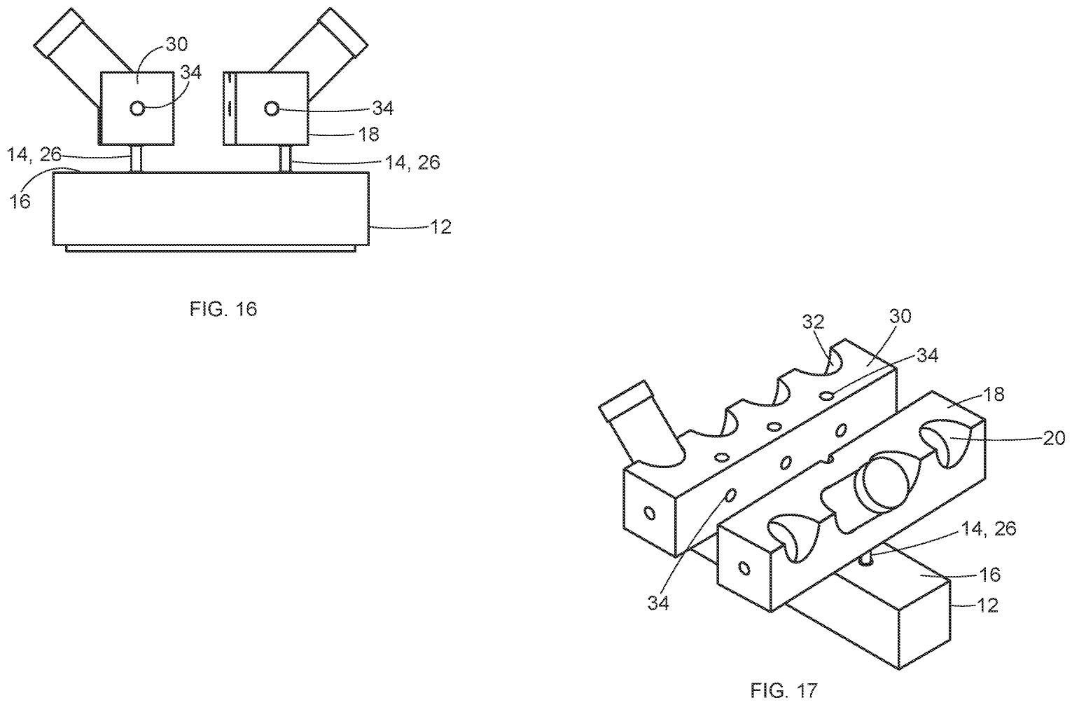

FIGS. 14 and 15 show side and perspective views of a base peg or stacking peg according to embodiments.

FIGS. 16 and 17 show a side and perspective views of a container rack according to embodiments.

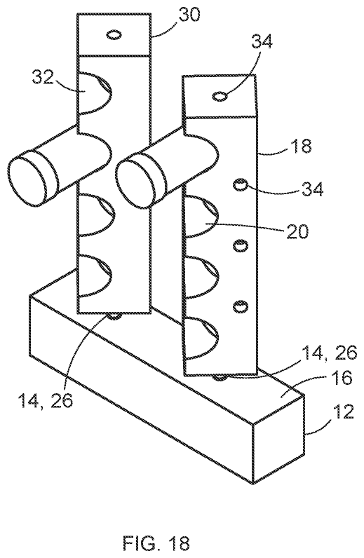

FIG. 18 shows a perspective view of a container rack according to embodiments.

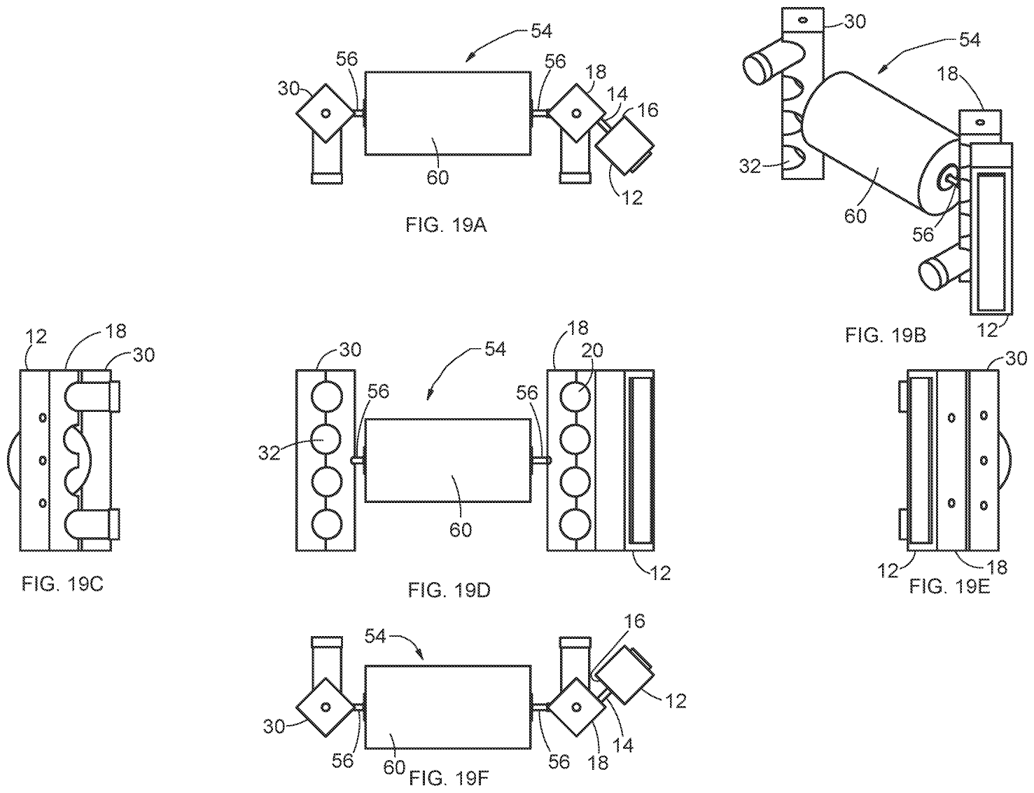

FIGS. 19A-19F show various views of a container rack according to embodiments.

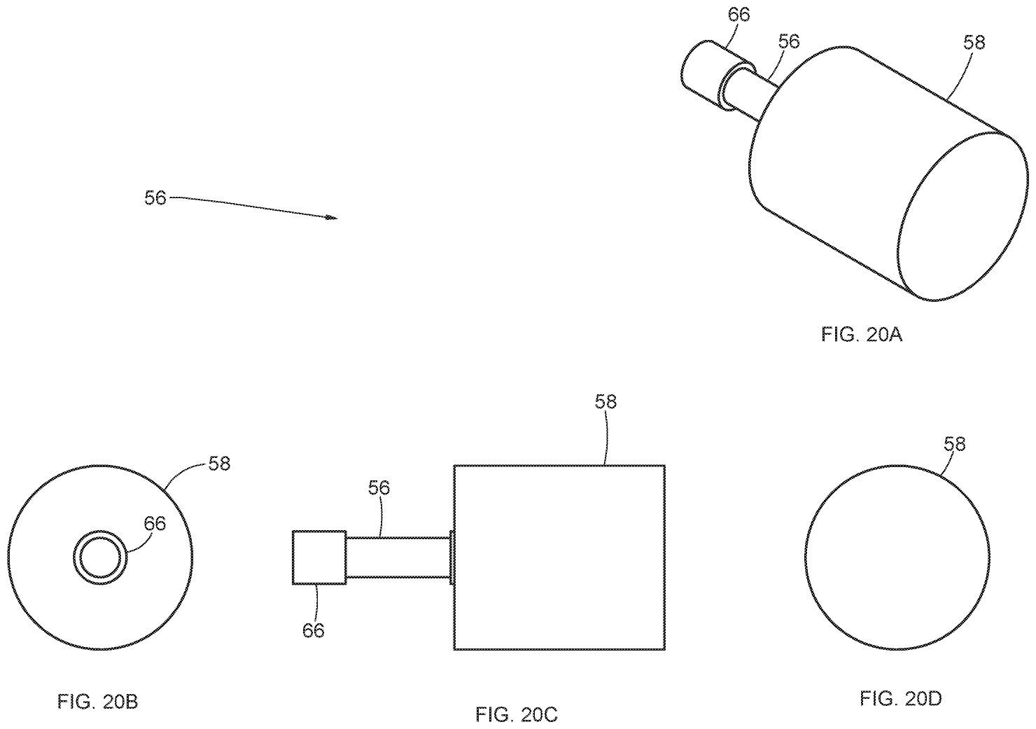

FIGS. 20A-20D show views of a paper towel peg according to embodiments.

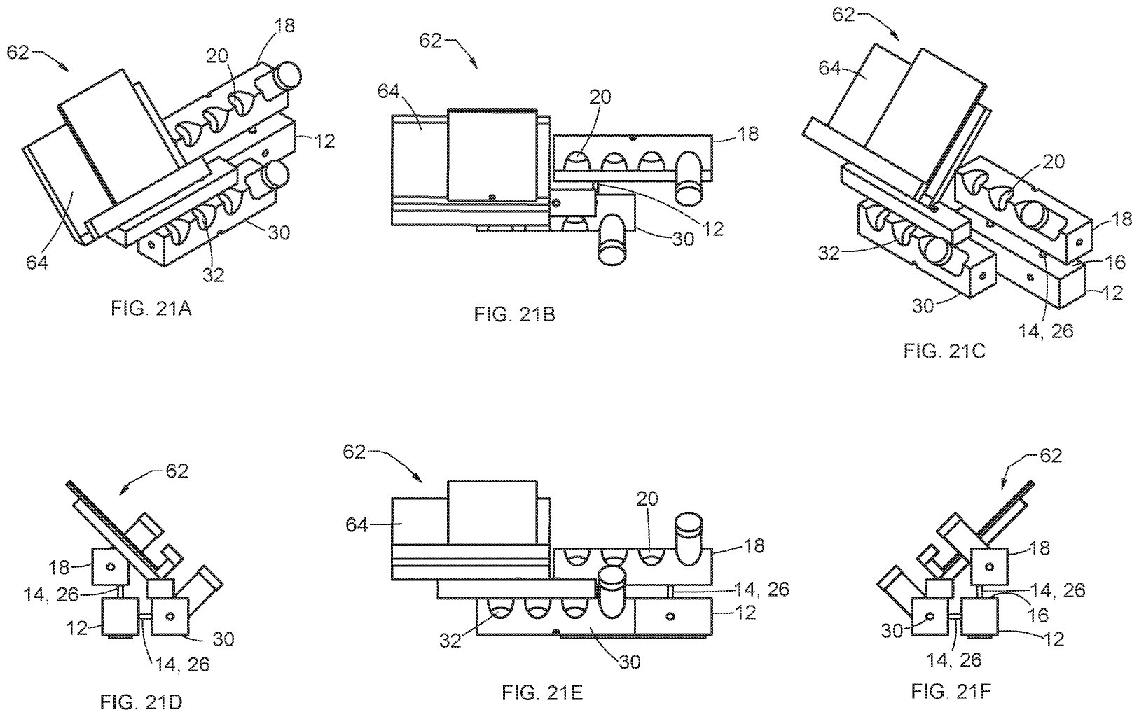

FIGS. 21A-21F show various views of a container rack according to embodiments.

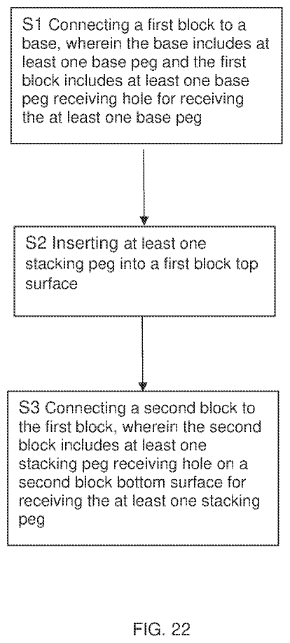

FIG. 22 shows a flow diagram for a method of deploying a container rack according to embodiments.

Any of the images are not necessarily to scale. The images are merely schematic representations and are not intended to portray specific parameters of the invention. The images are intended to depict only typical embodiments of the invention, and therefore should not be considered as limiting the scope of the invention.

### DETAILED DESCRIPTION

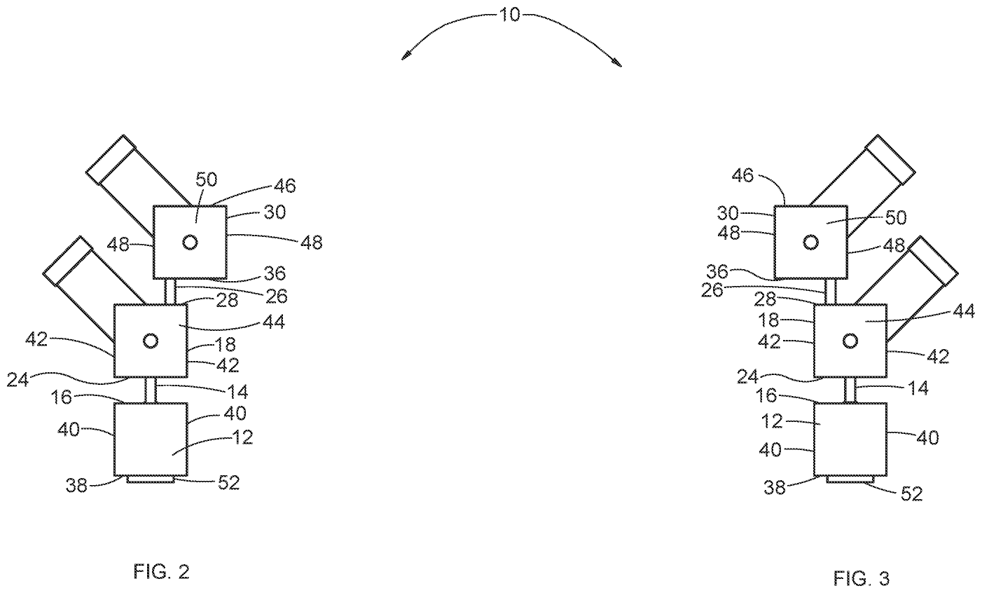

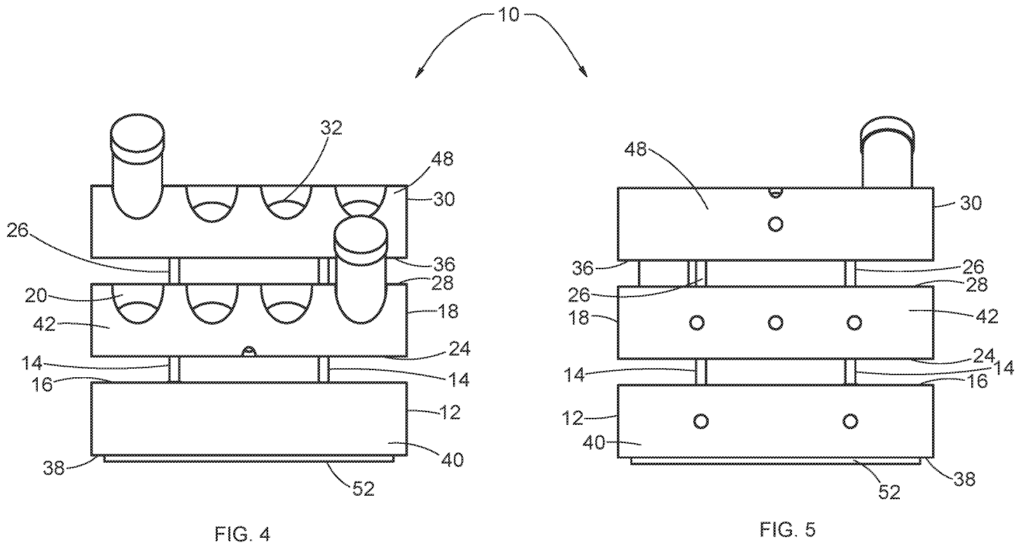

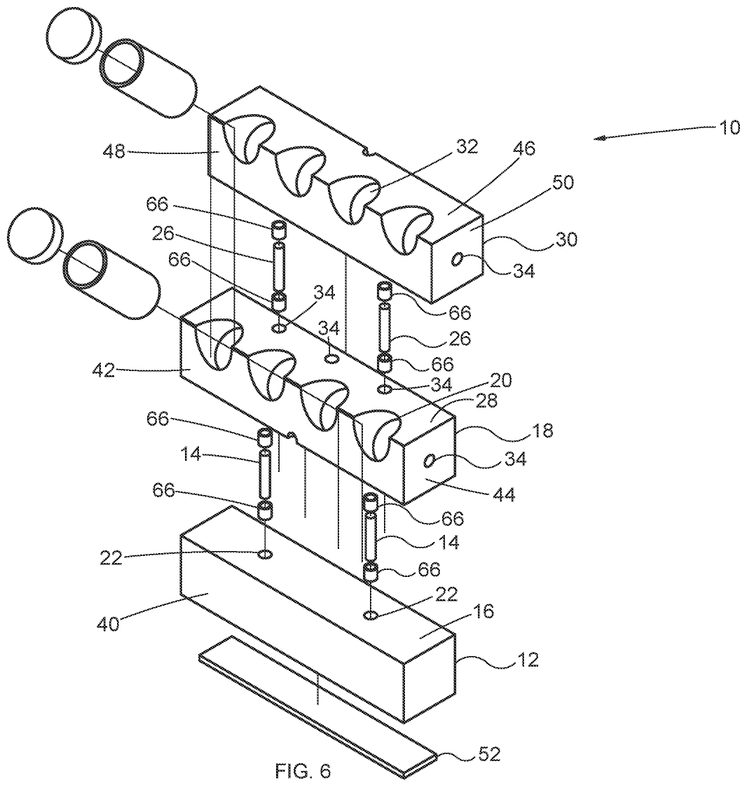

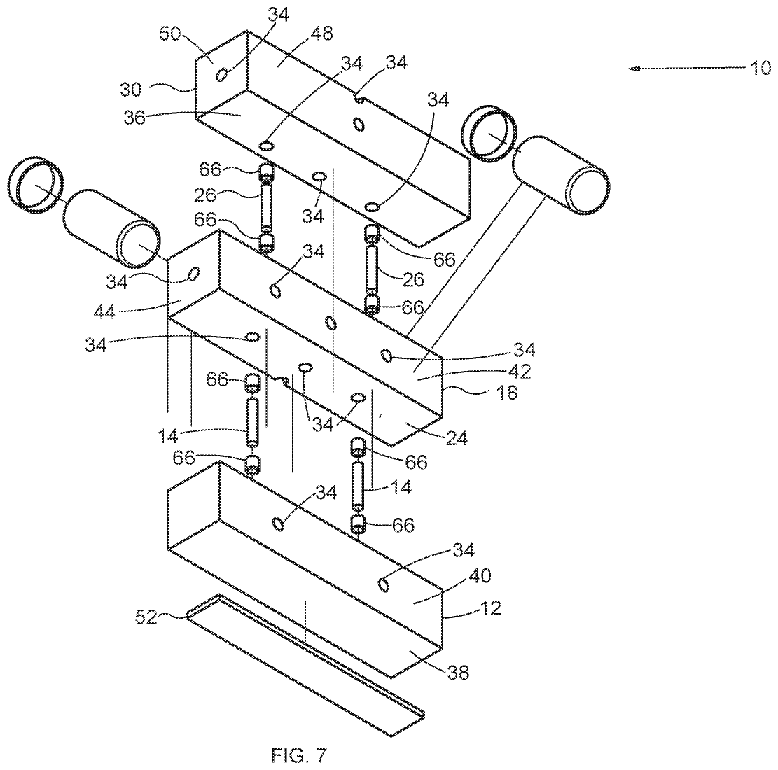

Referring now to the figures, FIG. 1 shows a container rack 10 in an assembled configuration. FIGS. 2 and 3 show end views of container rack 10. FIGS. 4 and 5 show front and back views respectively of container rack 10. FIGS. 6 and 7 show container rack 10 in exploded views—FIG. 6 is a top perspective view and FIG. 7 is a bottom perspective view. Container rack 10 includes a base 12, wherein the base 12 includes at least one base peg 14 extending from a base top surface 16; a first block 18, wherein the first block 18 includes at least one first block container hole 20, wherein the first block 18 includes at least one base peg receiving hole 22 on a first block bottom surface 24 for receiving the base peg 14, and wherein the first block 18 includes at least one stacking peg 26 extending from a first block top surface 28; a second block 30, wherein the second block 30 includes at least one second block container hole 32, wherein the first block 18 includes at least one stacking peg receiving hole 34 on a second block bottom surface 36 for receiving the stacking peg 26; wherein the base 12, first block 18, and second block 30 are connected and stacked. It will be readily apparent that container rack 10 may be any size or dimension.

FIGS. 8A-8I show front views of base 12—FIG. 8A perspective top view, FIG. 8B top view, FIG. 8C perspective top view, FIG. 8D end view, FIG. 8E front view, FIG. 8F end view, FIG. 8G perspective bottom view, FIG. 8H bottom view, and FIG. 8I perspective bottom view. FIGS. 9A-9I show back views of base block—FIG. 9A perspective top view, FIG. 9B top view, FIG. 9C perspective top view, FIG. 9D end view, FIG. 9E back view, FIG. 9F end view, FIG. 9G perspective bottom view, FIG. 9H bottom view, and FIG. 9I perspective bottom view. Base 12 includes a base bottom surface 38 and base top surface 16. Base 12 includes at least one base peg receiving hole 22 on base top surface 16. Base 12 may include at least one base peg receiving hole 22 on a base side surface 40

FIGS. 10A-10I show front views of first block—FIG. 10A perspective top view, FIG. 10B top view, FIG. 10C perspective top view, FIG. 10D end view, FIG. 10E front view, FIG. 10F end view, FIG. 10G perspective bottom view, FIG. 10H bottom view, and FIG. 10I perspective bottom view. FIGS. 11A-11I show back views of first block—FIG. 11A perspective top view, FIG. 11B top view, FIG. 11C perspective top view, FIG. 11D end view, FIG. 11E back view, FIG. 11F end view, FIG. 11G perspective bottom view, FIG. 11H bottom view, and FIG. 11I perspective bottom view. First block 18 includes first block bottom surface 24 and a first block top surface 28. First block 18 includes at least one base peg receiving hole 22 on first block bottom surface 24. First block 18 may include at least one stacking peg receiving hole 34 on first block top surface 28. First block 18 may include at least one stacking peg receiving hole 34 on a first block side surface 42. First block 18 may include at least one stacking peg receiving hole 34 on a first block end surface 44. First block 18 may include at least one stacking peg receiving hole 34 on an edge between first block bottom surface 24 and first block side surface 42. First block 18 may include at least one container hole 20

FIGS. 12A-12I show front views of second block 30—FIG. 12A perspective top view, FIG. 12B top view, FIG. 12C perspective top view, FIG. 12D end view, FIG. 12E front view, FIG. 12F end view, FIG. 12G perspective bottom view, FIG. 12H bottom view, and FIG. 12I perspective bottom view. FIGS. 13A-13I show back view of second block—FIG. 13A perspective top view, FIG. 13B top view, FIG. 13C perspective top view, FIG. 13D end view, FIG. 13E back view, FIG. 13F end view, FIG. 13G perspective bottom view, FIG. 13H bottom view, and FIG. 13I perspective bottom view. Second block 30 includes second block bottom surface 36 and a second block top surface 46. Second block 30 includes at least one stacking peg receiving hole 34 on second block bottom surface 36. Second block 30 may include at least one stacking peg receiving hole 34 on second block top surface 46. Second block 30 may include at least one stacking peg receiving hole 34 on a second block side surface 48. Second block 30 may include at least one stacking peg receiving hole 34 on a second block end surface 50. Second block 30 may include at least one stacking peg receiving hole 34 on an edge between second block bottom surface 46 and second block side surface 48. Second block 30 may include at least one container hole 32

Base 12 may be made from many materials. In one embodiment, base 12 is made from masonry. Base 12 may include a base pad 52 on the base bottom surface 38. Base pad 52 may be made of any material and may include felt, cork, or similar soft protective materials. First block 18 and second block 30 may be made from many materials. First block 18 and second block 30 may be made from wood, metal, plastic, composite, or any other sturdy material. Each block 18, 30 may include any number of container holes 20, 32. Container holes 20, 32 may be any geometric configuration to accommodate bottles, jars, boxes, and various shape and size containers.

In various embodiments, the size of base 12 or weight of base 12 allows stacking the blocks 18, 30 higher and creates cantilever type structures.

In one embodiment, container rack 10 may include a plurality of base pegs 14 and a plurality of base peg receiving holes 22, each base peg receiving hole 22 for receiving a corresponding base peg 14. In one embodiment, container rack 10 may include a plurality of stacking pegs 26 and a plurality of stacking peg receiving holes 34, each stacking peg receiving hole 34 for receiving a corresponding stacking peg 26.

FIGS. 14 and 15 show side and perspective views respectively of base peg 14 or stacking peg 26. Base peg 14 and stacking peg 26 are identical in structure. Base peg 14 and stacking peg 26 may include a cap 66 for each end of base peg 14 and stacking peg 26. Cap 66 is optional. Cap 66 may be included for adjusting a fit between pegs 14, 26 and base 12, first block 18, or second block 30. Base peg 14 may be fixed to base 12 or removable from base 12. Stacking pegs 26 and base pegs 14 may be fixed to or removable from first block 18. Stacking pegs 26 and base pegs 14 may be fixed to or removable from second block 30. Base pegs 14 and stacking pegs 26 may be made from any material. In one embodiment, base pegs 14 and stacking pegs 26 may be approximately ⅜″ (three eighth inch) diameter stainless steel rod approximately 2″ (two inch) long with approximately ½″ (one half inch) stainless steel tube at each end.

A person skilled in the art will readily recognize that many different configurations may include using one base peg 14 connection between the base 12 and first block 18 and may include using one stacking peg 26 connection between the first block 18 and second block 30. Different configurations may include adding additional pegs 14, 26 to support various dimensions and weights. Different configurations may include additional blocks 18, 30 in various configurations connected to the base 12. Embodiments may include steel blocks, wood connecting pegs, masonry connecting pegs, dual masonry base, or plastic and other composite materials.

FIGS. 16 and 17 show a side and perspective view respectively of one configuration of container rack 10. In this configuration, first block 18 and second block 30 are each connected to base 12. First block 18 and second block 30 are oriented horizontal and perpendicular to base 12.

FIG. 18 shows a perspective view of one configuration of container rack 10. In this configuration, end of first block 18 and end of second block 30 are each connected to base 12. First block 18 and second block 30 are oriented vertical to base 12.

In one embodiment referring to FIGS. 19A-19F, container rack 10 may include a paper towel rack 54. In this embodiment, paper towel rack 54 connects to and between second block 30 and first block 18. Paper towel rack 54 includes paper towel rack pegs 56 with one paper towel rack peg 56 at each end of paper towel rack 54. Paper towel rack pegs 56 may be inserted in the stacking peg receiving holes 20, 34 of first block 18 and second block 30. FIGS. 20A-20D show views of a paper towel peg 56. Paper towel peg 56 may include a cap 66 for one end of paper towel peg 56. The opposite end of paper towel rack peg 56 may include a paper towel rack adapter 58 for inserting into a paper towel roll 60.

In one embodiment referring to FIGS. 21A-21F, container rack 10 may include a book rack 62. In this embodiment, first block 18 and second block 30 are connected to adjacent sides of base 12. Book rack 62 may be connected to first block 18 or second block 30 with book surface 64 of book rack 62 oriented diagonally to container rack 10.

FIG. 22 shows a flow diagram for one embodiment of a method of deploying the container rack. The method includes S1 connecting the first block 18 to the base 12, wherein the base 12 includes the base peg 14 and the first block 18 includes at least one base peg receiving hole 22 for receiving at least one base peg 14; and S2 inserting at least one stacking peg 26 into first block top surface 28 and the second block 30 is connected to the first block 18, wherein the second block 30 includes at least one stacking peg receiving hole 34 for receiving at least one stacking peg 26.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A container rack, comprising:
a base, wherein the base includes at least one base peg extending from a base top surface;
a first block, wherein the first block includes at least one first block container hole, wherein the first block includes at least one base peg receiving hole on a first block bottom surface for receiving the base peg, and wherein the first block includes at least one stacking peg extending from a first block top surface;
a second block, wherein the second block includes at least one second block container hole, and wherein the second block includes at least one stacking peg receiving hole on a second block bottom surface for receiving the at least one stacking peg;
wherein the base, first block, and second block are connected and stacked.

2. The container rack of claim 1, wherein the first block and second block includes wood or metal.

3. The container rack of claim 1, comprising a plurality of base pegs extending from the base and a plurality of base peg receiving holes in the first block bottom surface, each base peg receiving hole for receiving a corresponding base peg.

4. The container rack of claim 1, comprising a plurality of stacking pegs extending from the first block and a plurality of stacking peg receiving holes in the second block bottom surface, each stacking peg receiving hole for receiving a corresponding stacking peg.

5. The container rack of claim 1, wherein the base includes masonry.

6. The container rack of claim 1, wherein the base includes a base pad on a base bottom surface.

7. The container rack of claim 6, wherein the base pad includes one of felt or cork.

8. The container rack of claim 1, wherein the base pegs and stacking pegs comprise stainless steel rods.

9. The container rack of claim 8, wherein the base pegs and stacking pegs include caps on each end.

10. The container rack of claim 1, wherein the base pegs and stacking pegs are one of fixed or removable.

11. A container rack, comprising:
a base, wherein the base includes at least one base peg and at least one stacking peg extending from a base top surface;
a first block, wherein the first block includes at least one first block container hole, wherein the first block includes at least one base peg receiving hole on a first block bottom surface for receiving the at least one base peg;
a second block, wherein the second block includes at least one second block container hole, wherein the second block includes at least one stacking peg receiving hole on a second block bottom surface for receiving the at least one stacking peg;
wherein the base and first block are connected, and wherein the base and second block are connected.

12. The container rack of claim 11, wherein the first block and second block includes wood or metal.

13. The container rack of claim 11, wherein the base includes masonry.

14. The container rack of claim 11, wherein the base includes a base pad on a base bottom surface.

15. The container rack of claim 14, wherein the base pad includes one of felt or cork.

16. The container rack of claim 1, wherein the base pegs and stacking pegs comprise stainless steel rods.

17. The container rack of claim 16, wherein the base pegs and stacking pegs include caps on each end.

18. The container rack of claim 1, wherein the base pegs and stacking pegs are one of fixed or removable.

19. A method of deploying a container rack, the method comprising:
connecting a first block to a base,
wherein the base includes at least one base peg and the first block includes at least one base peg receiving hole for receiving the at least one base peg; and
inserting at least one stacking peg into a first block top surface; and
connecting a second block to the first block, wherein the second block includes at least one stacking peg receiving hole on a second block bottom surface for receiving the at least one stacking peg.

20. The container method of claim 19, comprising a plurality of base pegs extending from the base and a plurality of base peg receiving holes in the first block bottom surface, each base peg receiving hole for receiving a corresponding base peg; and
a plurality of stacking pegs extending from the first block and a plurality of stacking peg receiving holes in the second block bottom surface, each stacking peg receiving hole for receiving a corresponding stacking peg.
